(19) United States
(12) Patent Application Publication
(10) Pub. No.: US 2005/0280894 A1
(43) Pub. Date: Dec. 22, 2005

(54) Apparatus for creating a scanning-column backlight in a scanning aperture display device

(76) Inventors: David Hartkop, Central Point, OR (US); Jason Dunn, Playa Del Ray, CA (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 11/145,792

(22) Filed: Jun. 6, 2005

Related U.S. Application Data
(63) Continuation-in-part of application No. 10/817,592, filed on Apr. 2, 2004.

(51) Int. Cl. G02B 27/22

(52) U.S. Cl. 359/464

(57) ABSTRACT

The backlight for use in scanning aperture display device utilizes a light or LED bank arranged in a predetermined configuration, a light carrying device for carrying the light generated by the LED bank to the scanning apertures of the display device, and a mask adapted to capture and focus the light generated by each LED into the respective light carrying device. The backlight is positioned behind the transmissive display of the scanning aperture display device.

### CROSS REFERENCE TO RELATED APPLICATIONS

This application is a Continuation in Part of co-pending U.S. patent application Ser. No. 10/817,592 filed Apr. 2, 2004.

### BACKGROUND OF THE INVENTION

1. Field of the Invention

The present invention relates to image reproduction, and more particularly, it relates to a scanning aperture holographic display for 2D and 3D image reproduction.

2. Description of the prior art

Various approaches to 3D image reproduction have been experimented with and implemented in different aspects of industrial life. Many of today's current imaging applications are requiring of more detail and the ability to “look around” or see all sides of an image in true 3D representation. Some exemplary applications for such imaging include Medical, Military and other industrial and recreational fields.

Among the first generation of 3D image reproduction is the Stereoscope. Stereoscopes were first invented in 1833 by Sir Charles Wheatstone and were designed to produce a three dimensional image that one could see through a special viewer. It requires a special camera that takes two photographs at slightly offset angles. When viewed through the stereoscope, each eye is presented with a slightly different image that would create a three dimensional effect.

Stereoscope technology is one of the most widely available technologies, showing up in 3D movies, virtual reality, simulation, etc. Stereoscopes require special headsets or glasses in order to view properly, and have a fixed perspective that does not change for position.

Examples of these technologies include: Anaglyph—which uses a pair of red and blue color glasses. The stereoscopic effect is achieved easily with any kind of display that includes LCD, and Projectors; Polarizing Filter method—By using a pair of polarizing glasses, stereoscopic images are also easily seen without losing colors. However, ordinary computer displays cannot be used for such applications and therefore require the use of a projection type display for this method. To realize the stereoscopic effect, a polarizing screen designed for the projector must be attached in front of the lens; Synchronizing Shutter—By using a pair of synchronizing shutter glasses, you can see the stereoscopic effect by using any computer display. Synchronizing shutter glasses are a little more expensive than others and the viewed image becomes a little darker. A major limitation of stereoscope technique is that it produces a single fixed perspective regardless of viewing angle and as such, are not true holograms.

Another later version of the Stereoscope is the Auto-stereoscope, which was designed to negate the need for specialized eyewear by the user in order to view the 3D images.

Variations in the Auto-Stereoscopes include:

A Lenticular screen uses a ridged screen to separate two different images so that either eye sees the one designated for it. The lenticular screen is commonly seen in novelty gifts, baseball cards and advertising displays. They can also utilize projectors in which the binary images are projected onto a screen, but the same limitations apply. Drawbacks include cost of manufacture, low quality of the image, significant tearing (broken or misplaced image elements), limited field or view and fixed perspective. The Lenticular screen is not a true hologram.

Holographic Optical Elements (HOE) uses striped horizontal HOE's and a distant light source to create a three dimensional effect. This is an emerging technology that creates a stereoscopic image for the viewer. However, HOE has a limited field of view that can be mechanically shifted by moving the light source in conjunction with a head mounted positioning system. Thus, HOE has a fixed perspective and is therefore not a true hologram;

The Grid barrier screen method also allows the viewer to see the stereoscopic images with naked eyes. The principle of this method is similar to that of the lenticular screen method as it applies the optical effect of a pinhole in place of a lens. However, the barriers cover a part of image lines, so the stereoscopic image becomes darker than the lenticular screen method;

The Prism screen is similar to a lenticular screen, however, prisms overlay a liquid crystal display (LCD) screen as opposed to being projected upon it. Thus, prism screens have a fixed display angle, as well as fixed perspective; and

Curved screen projection—uses a lensatic image warp and curved screen to create the illusion of an immersive 3 dimensional environment. This is used for simulators for training. It does not achieve a true, three-dimensional holographic effect.

Other 3D image reproduction technology includes Holography. Holography was initially created in the 1940's using mercury arc lamps, these took off in the 1960's with the development and application of lasers. The holographic image generated results from the quantum interference between a laser shined on stationary object and a reference beam. The interference is recorded in a film like medium such that, when viewed, recreates the light patterns of the original object, showing a three dimensional image.

Variations in Holograph Technology include:

Voxels—which create a hologram by compositing multiple slices of 2D medical imagery onto a single piece of holographic film. This is slow and cumbersome process;

Real Time Holography—this is an emergent technology that uses configurable lasers to recreate the holographic image floating in space. Roadblocks include the vast amount of information necessary, the complete lack of color, and the difficulties of dealing with and replicating quantum interactions;

Volumetric display—creates a static or active volume in which 3 dimensional images can be displayed. Light is painted on either a rapidly rotating ‘canvas’ (active), or in a liquid or solid dispersion medium (static). These displays disallow interaction with the hologram, limiting the effectiveness and commercial nature of the process;

Micro mirror projection—uses an array of independently mobile micro-mirrors and lasers to recreate the interactions of a light in a holographic image. Micro mirror projection is able to create full motion holograms but at the price of limited resolution and color scale; and,

Mirror boxes—use mirrors to ‘project’ the 3D image of a physical object contained therein outside of the box. This is an illusion and a parlor trick, without any real commercial merit except as a curiosity.

### SUMMARY OF THE INVENTION

According to one aspect of the invention, the three dimensional display device includes a display screen having pixels and a pixel width, a scanning back light disposed behind said transmissive display screen, and a gap separating said display screen and said aperture plate. The gap being within a range of 0.1 cm-5 cm. The three dimensional display is capable of providing multiple different perspectives viewable from multiple different user viewing angles.

According to one aspect of the invention, the three dimensional display device includes a display screen having pixels and a pixel width, an aperture plate disposed in front of said display screen, and a gap separating said display screen and said aperture plate. The gap being within a range of 0.1 cm-5 cm. The three dimensional display is capable of providing multiple different perspectives viewable from multiple different user viewing angles.

According to another aspect of the invention, the three dimensional display device includes a display screen having pixels and a pixel width, an aperture plate disposed in front of said display screen and having apertures, and a distance separating the display screen and the aperture plate. In this embodiment, the display device generates a three dimensional display exhibiting both horizontal and vertical parallax.

According to another aspect of the invention, the solid state three dimensional display device includes a display matrix, a substrate, and an LCD dynamic parallax barrier. The display matrix and the LCD dynamic parallax barrier are bonded to opposing sides of the substrate. This solid state embodiment provides a display device capable of generating a three dimensional display exhibiting both horizontal and vertical parallax.

The method for manufacturing a solid state three dimensional device according to an aspect of the invention includes the steps of providing a substrate of a predetermined thickness and material, bonding a display matrix to one side of the substrate, and bonding an LCD dynamic parallax barrier to the substrate opposite said display matrix. The smaller the predetermined thickness of the substrate, the wider viewing angle produced by the three dimensional device.

According to yet another aspect of the invention, the solid state three dimensional display device includes a flat screen Ferroelectric LCD display matrix, a substrate and a flat screen Ferroelectric LCD dynamic parallax barrier. The display matrix and the FLCD dynamic parallax barrier are bonded to opposing sides of the substrate. This solid state embodiment provides a display device capable of generating a three dimensional display exhibiting both horizontal and vertical parallax.

According to further embodiments, the three dimensional display device includes a flat screen display having pixels and a pixel width, a flat aperture plate disposed in front of the display screen and a gap separating the display screen and the aperture plate. The gap is preferably within a range of 0.1 cm-5 cm. This three dimensional display provides multiple different perspectives viewable from multiple different user viewing angles.

According to other embodiments, the three dimensional display device includes hybrid screen display having pixels and a pixel width, a flat aperture plate disposed in front of the display screen, and a gap separating the display screen and the aperture plate The gap being within a range of 0.1 cm-5 cm. This three dimensional display is capable of providing multiple different viewable perspectives based on horizontal and vertical viewing angles.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a block diagram of the scanning aperture holographic display system according to an embodiment of the invention;

FIG. 2 is a plan view of the geometric relations of 3D display system according to an embodiment of the invention;

FIG. 3 is a plan view demonstrating the angular resolution considerations for the 3D display system according to an embodiment of the invention;

FIG. 4 is a plan view demonstrating the angular resolution considerations for the 3D display system according to an embodiment of the invention;

FIGS. 5 and 6 demonstrate aperture view equivalence according to an embodiment of the invention;

FIGS. 7 and 8 demonstrate persistence of vision according to an embodiment of the invention;

FIGS. 9a, 9b and 9c shows variations in the visual constraints of virtual images traced through aperture to real image;

FIG. 10 is block diagram of the basic construction of the scanning aperture holographic display system according to an embodiment of the invention;

FIG. 11 is block diagram of the basic construction of the scanning aperture holographic display system according to another embodiment of the invention;

FIG. 12 is block diagram of the basic construction of the scanning aperture holographic display system according to yet another embodiment of the invention;

FIG. 13 is block diagram of the basic construction of the scanning aperture holographic display system according to a further embodiment of the invention;

FIG. 14 is block diagram of the basic construction of the scanning aperture holographic display system according to yet a further embodiment of the invention; and

FIG. 15 is plan view of an aperture plate having a 24×18 resolution with discreet horizontal and vertical viewing angles for use with a 2-axis scanning aperture 3D display system according to an embodiment of the invention;

FIG. 16 is a top view graphical representation of the intersection of maximal angle projections from the most distant apertures in a 2 axis system according to an embodiment of the invention;

FIG. 17 is a side view graphical representation of the intersection of maximal angle projections from the most distant apertures in the vertical direction;

FIG. 18 is graphical view of the uncompromised viewing volume from behind the 3D display according to an embodiment of the invention;

FIG. 19 is a graphical view of the uncompromised viewing volume from in front of the 3D display according to an embodiment of the invention;

FIG. 20 is a schematic representation of a solid state 3D display system according to an embodiment of the invention;

FIG. 21 is a schematic representation of another solid state 3D display system according to another embodiment of the invention;

FIG. 22 is a schematic representation of another solid state 3D display system according to another embodiment of the invention;

FIG. 23 is a graphic representation of the maximum viewing angle for a given substrate according to an embodiment of the invention;

FIG. 24 is a schematic representation of the layers of the scanning column backlight according to an embodiment of the invention;

FIG. 25 is a schematic view of an LED configuration and relation to mask and light guides according to an embodiment of the invention;

FIG. 26 is diagrammatic representation showing the illumination of narrow columns of light by selected LED columns according to an embodiment of the invention;

FIG. 27 is a schematic view of the mask layer interface with the LED bank according to an embodiment of the invention; and

FIG. 28 is exemplary view of the operation of the stacked light guides according to an embodiment of the invention; and

FIG. 29 is a schematic representation of the layers of the scanning column backlight according to another embodiment of the invention.

### DETAILED DESCRIPTION OF PREFERRED EMBODIMENTS

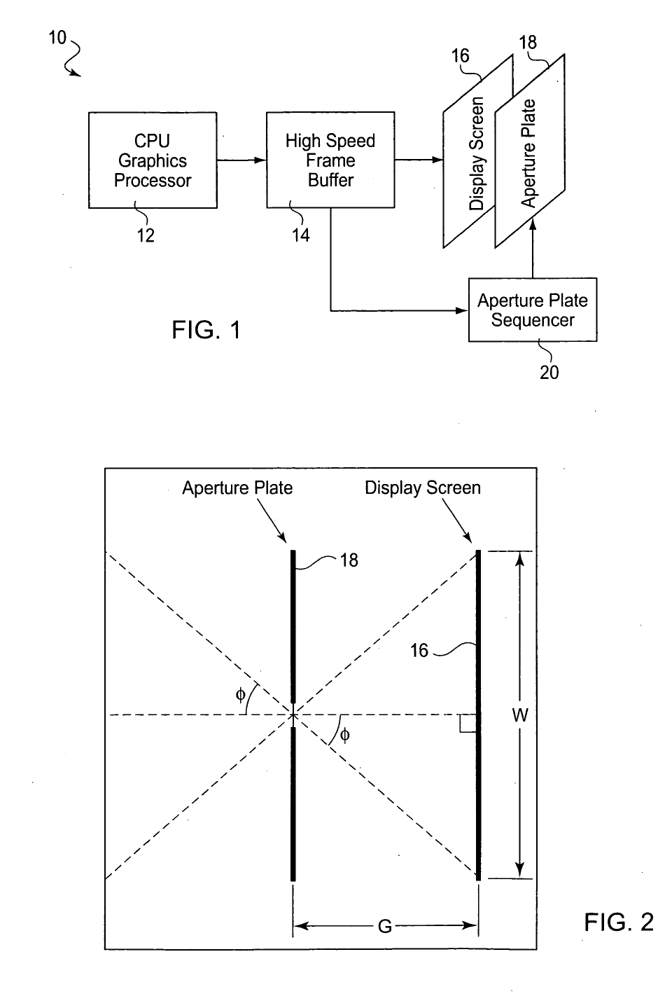

Referring to the block diagram of FIG. 1, there is shown a general depiction of the scanning aperture three dimensional display system 10 according to an embodiment of the invention. In a basic form, the system includes a central processing unit/graphic processor 12, a high speed frame buffer 14, a display screen 16, an aperture plate 18 and an aperture plate sequencer 20.

The embodiment of FIG. 1 is a solid state example of the invention, having no moving parts. In accordance with various embodiments, described herein, the display screen 16, aperture plate 18, aperture plate sequencer 20 and other hardware/software components can be implemented in many different ways without departing from the spirit of the invention. In accordance with other embodiments, the apertures in the aperture plate 18 can be of different configuration. These embodiments are discussed in detail below, however a brief explanation of the operating principles and considerations in the implementation of the scanning aperture 3 dimensional (3D) image display system of the present invention are explained first.

Images produced by means of the scanning aperture display of the present invention can be termed holograms in the broader conceptual definition. As described earlier, standard holography is based on optical interference to produce unique light patterns for a given viewing angle. In contrast, the scanning aperture display relies on the viewer's parallax angle and human persistence of vision.

The fundamental basis for the reconstruction of three-dimensional images using the scanned aperture technique is a property termed herein as aperture-view equivalence (AVE). Aperture-view equivalence (AVE) describes an aperture as being a window through which only one dimension (a single ray of light at a specific angle to the normal) may be viewed by a viewer at a particular angle to that aperture. The viewer's angle of view is considered to be at a fixed distance from the small aperture, and to rotate in longitude and latitude about a point fixed in the center of the aperture. Thus, it becomes clear that total viewable light pattern transmitted through a single aperture can be described by just two dimensions: a rotation (or translation) along a vertical axis,.and a rotation (or translation) along a horizontal axis. In essence, any light source, be it three or two-dimensional will be transmitted through an aperture in just two dimensions. In this way, the views of a three-dimensional object or a two dimensional projection through an aperture can be quantitatively equivalent.

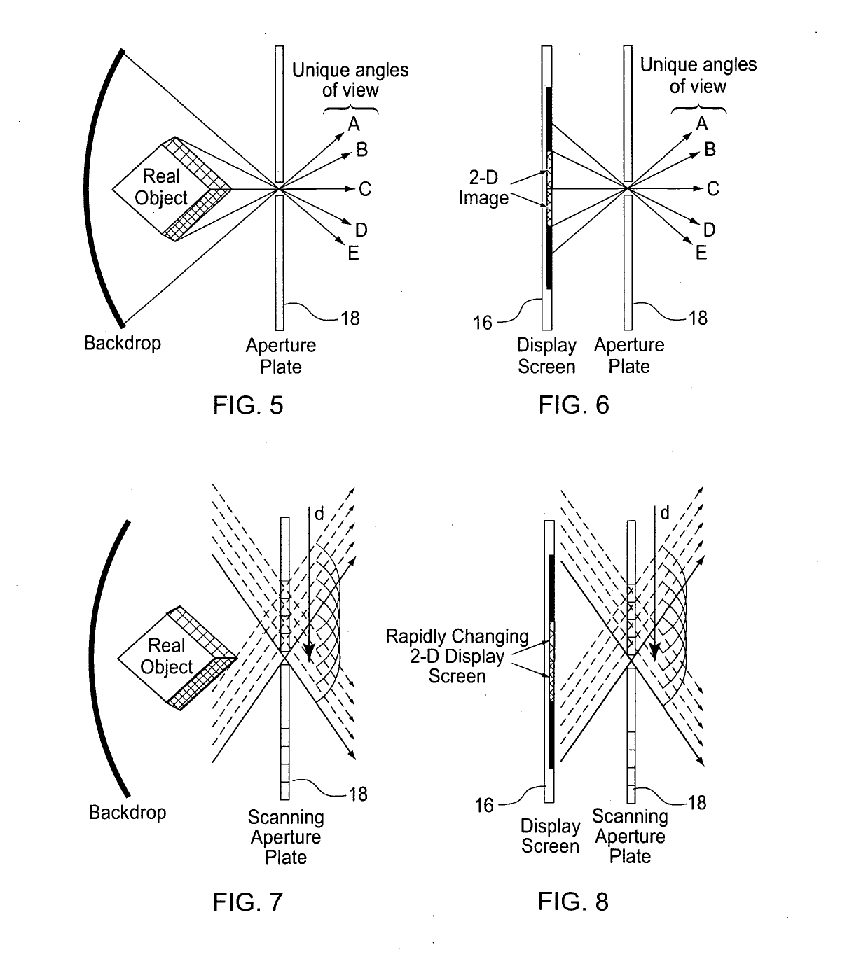

FIGS. 5 and 6 demonstrate AVE. In FIG. 5, a real object, in this case a cube, floats before a black backdrop. The cube is viewed through the aperture and can be seen from anywhere between angles B and D. Angles A and E provide only a view of the backdrop. FIG. 6 utilizes a flat display screen 16 in place of the real object. It is noteworthy, however, that the views through the aperture from angles A through E are identical to those in FIG. 5.

Image Construction through Persistence of Vision

Due to AVE, it is possible to mimic the appearance of a three-dimensional object with a two-dimensional view screen, provided that the field of view is projected through a single visual point (i.e., an aperture). What remains is a method for constructing a continuous image field made up of many such individual apertures. It is not spatially practical to simply place apertures side-by-side, as there is a required distance that must be maintained between each in order to afford sufficient non-overlapping viewing angles with respect to the 2-D display screen behind. Such a screen would either appear as a series of discreet dots against a black background, or would make a trade off in angular resolution in order to place apertures closer together. The preferred method to preserve both angular resolution and resolution of the display field under this paradigm is to dramatically increase the resolution of the 2-D display screen. This, for many practical reasons, is not a desirable solution. An alternative to the use of static apertures as discussed above is the use of scanning, or dynamic apertures. Such apertures are made to change location in the display field with respect to time, and, because of human ‘persistence of vision’ can be used to construct a fully-filled display field.

For the purpose of this discussion, “Persistence of Vision” (POV) is defined as a property of human vision that causes it to interpret many brief visual states as a single or continuous perceived visual state. For example, a row of sequentially flashing lights will appear to glow simultaneously if the flash rate of each light is substantially high enough. As a simplified example, a single blinking light will appear to glow continuously if its rate of blinking is fast enough. For a general benchmark, a light blinking at or above roughly 50 Hz will appear to glow continuously. This property of vision has also been found to apply to the viewing of light transmitted through shuttered or moving apertures. This suggests a new method for filling a display field with only light transmitted through apertures. If each aperture exists in at a location in the display field for only a brief period of time, the open apertures in the display field will be made to exist at a new location, shifted spatially by the width or height of one aperture. This sequencing of aperture position continues until all points of the display field have been occupied by an open aperture for a brief period of time. The sequence then resets. Assuming the entire sequence can be performed at or above 50 Hz, that is, within the time of 1/50^{th} of a second, the translation of individual aperture positions will not be apparent.

FIG. 7 demonstrates how an aperture may be scanned across a viewer's visual field to provide a more complete view of the cube for the viewer. The rapidly moving aperture, in this case a slit, does not appear as a single moving band of view. Instead, because of ‘persistence of vision,’ the entire scanning-aperture plate appears to become transparent for a moment. If the scanning is rapidly repeated, the plate will remain transparent to the viewer. The viewer will have an accurate three-dimensional view through the image plate at a truly three-dimensional object. FIG. 8 shows how an identical aperture may be scanned before a two-dimensional display device 16 in order to ‘blend together’ the positions of individual apertures, similarly constructing an entire display field. In order to reconstruct a truly three-dimensional image, however, the display screen 16 must represent an accurate two-dimensional projection with respect to the given aperture position. For this reason, every change in aperture position (d) requires a change in the 2-D image displayed. To clarify, the perspective from each different viewing angle to be made available requires the display of a separate 2-D image behind each momentarily open aperture. Apertures are sequenced in a cyclic manner, the period of each cycle being less than the persistence of vision threshold of human sight. With these conditions met, the view of a virtual object through such a display will appear equivalent to that of a real object in three- dimensional space.

FIG. 2 shows the geometric relationship between the display system's Maximum Viewing Angle (given as Φ in degrees), the Gap (given as G, in meters), and the Aperture Projection Width (given as W, in meters). The Aperture Projection Width W is the width of a region of image on the display screen directly behind the aperture, having a width equal to the width of the aperture multiplied by the number of discrete viewing angles. It is intended to be viewed over a specific range of angles through the aperture, and so is centered directly behind the given aperture. The Maximum Viewing Angle Φ defines the maximum angle (away from the normal projection through the aperture) at which light originating from within the Aperture Projection Width is still visible through the aperture. The Gap G is defined as the distance measured from the plane of the optically active region of the aperture plate 18 to the light-emitting surface of the video display screen 16. Gap G can be any distance, but most commercially acceptable embodiments will have a gap in a range of 0.1 cm-5 cm, according to various embodiments of the invention. The mathematical relationship between these elements in proper configuration is given as follows:

$$tan ( Φ ) = \frac{W}{2 G}$$

The value of W can be described as the product of the aperture width (given as P, in meters) and the total number of discreet viewable angles to be constructed by the display (given as A.)
W=PA
By substitution, the length of G and the Maximum Viewing Angle of the display relate to A and P as given:

$$tan ( Φ ) = \frac{PA}{2 G} = \frac{W}{2 G}$$

For a given implementation, the value of P (i.e., the aperture width), is also equal to (or slightly larger than the pixel width. Because the width of the aperture is close to the width of a pixel on the display screen, the resolution of the 3D image will approach or match the resolution of the display screen.

The key to the effect of constructing true 3-dimensional images is the ability to produce a variety of discreet viewing angles, which radiate away from any particular point on the screen. In effect, each point on the display screen can be observed to have several different values of brightness and color, depending on the viewer's perspective. A single axis system (meaning only horizontal parallax) has discreet viewable angles viewed through vertical slit-type aperture. The single axis system may be viewed by moving horizontally while observing the screen. A two-axis system (having both horizontal and vertical parallax, described in later embodiments) has discreet viewable angles viewed through different type apertures (e.g., pinholes, etc.). The two axis system may be viewed by moving horizontally as well as vertically while observing the screen.

During operation of a scanning aperture display, the number of discreet viewable angles A will most likely be less than the display screen's total pixel-count along the axis in consideration. (Pixel count for an axis, or resolution R). In order to maximize light output of the display, multiple apertures can be used at once. Optimally, an open aperture will be located every A'th aperture over R pixels. The following equation describes the relationship between A, R, and the total number of open apertures for a given moment (given as whole number a.):

$$a = \frac{R}{A}$$

This equation assumes that R is a whole number multiple of A. It is not necessary for this to be true, but it is somewhat convenient when designing a system.
Frame Rate and Aperture Response Time

During operation, the elements of the aperture plate must rapidly change states in sequence, transitioning momentarily from opaque to transparent and back. This succession of rapid state transitions emulates a moving or scanning aperture, either a pinhole, a slit or other aperture configuration depending on the aperture type. For each transparent ‘aperture’ configuration, a different video image is displayed on the display screen behind. The frame rate r (frames per second) of the required display screen is described in terms of viewable angles A:
r=(refresh rate?)(A)
This relationship acknowledges the fact that, in order to visually blend or composite the sequencing of open aperture positions, a complete scan cycle must be accomplished at a refresh rate sufficiently fast enough that the human eye will not detect the scanning effect. It is generally accepted that a refresh rate of approximately 50 times per second is sufficient. This cycle rate must be maintained regardless of the total value of A.

Given that a large number of discreet angles is desirable and that total sequential-cycle frequency of these angles must remain at or above 20 Hz, the optical response time for a given shutter is somewhat demanding. The Aperture Optical Response Time T (in seconds) is as follows:

$$T = \frac{1}{2 ( r )}$$

This figure is given as slightly conservative in order to prevent unwanted angular cross talk, which produces undesirable fogging or smearing of the image. Those of ordinary skill will recognize that suitable images can be produced with optical response times nearly twice as long as described in the equation above, but best results are gained with faster response.
Consideration for Angular Resolution

When designing an implementation of scanning aperture holographic display technology of the present invention, an important concept to understand and utilize properly is that of Angular Resolution. The Angular Resolution (AR) for a given display refers to the total number of discreet angles encountered per unit length along the observer plane, at a particular observer distance.

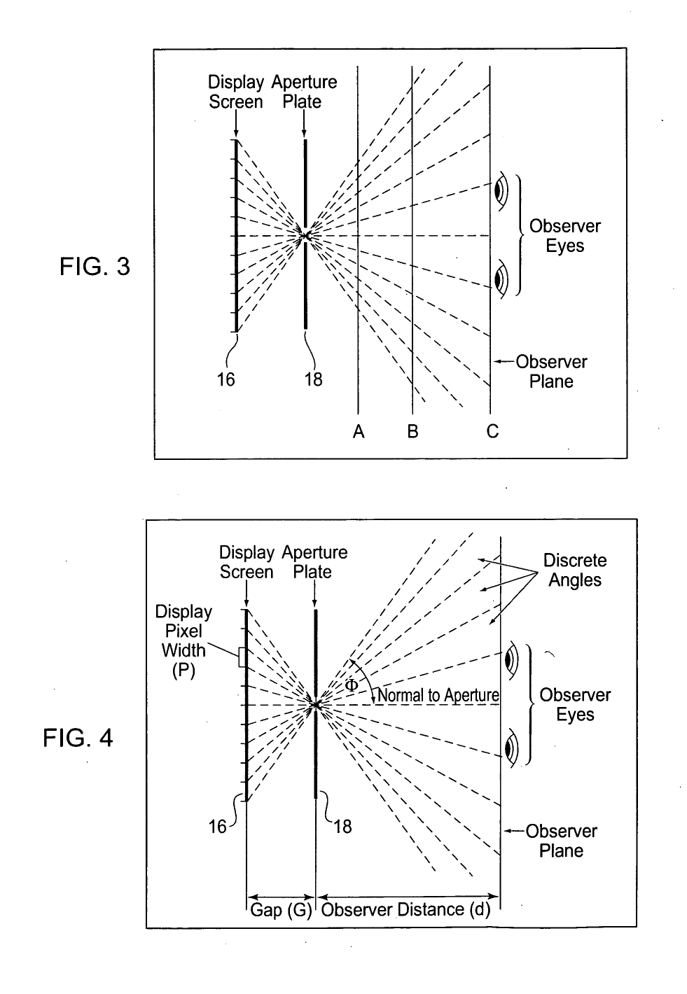

Referring to FIG. 3, discreet angles (separated in the Figure by dashed lines) radiate away from the aperture toward the observer's eyes. The observer's eyes are considered to be directly on the observer plane, which is parallel to the aperture plate. Notice the intersection of the discreet angles with observer planes at different distances, A, B, and C from the aperture plate 18; the total number of discreet angles per unit length of the observer plane decreases as the distance from the aperture plate 18 increases. It is also interesting to note that the observer eyes at the observer plane C encounter different discreet angles, and can thus perceive stereoscopic parallax (See FIG. 4). By shifting the head left or right (along a horizontal axis), the eyes will encounter new and different discreet angles, maintaining an adaptive and accurate parallax over a range of angles. Should the observer move too far from the aperture plate, or there simply be too few discreet angles, both eyes will fall within the same discreet angle. When this occurs, the observer experiences stereoscopic breakdown, at which point the image becomes a simple 2-D rendering. For this reason, it is important to configure the scanning aperture 3D holographic display system of the present invention to maximize angular resolution for a given range of observer plane distances.

The Minimum Angular Resolution at which stereoscopic separation is maintained can be calculated as a ratio between the minimum number of required angles for stereoscopic view (i.e., 2 angles), and the average separation between human eyes, accepted to be approximately 65 mm. Thus, the angular resolution was found to be close to 31, given in discreet angles per meter:
(2 discreet angles)/(65 mm between observer eyes)=31 discreet angles/meter
This is the absolute minimum required for the observation of a 3-dimensional image over the full range of display angles. With a display set to this minimum, however, an image can be seen to ‘jump’ or ‘slip’ slightly when the viewer's eyes transition from one set of discreet angles to another. Much better results can be achieved by doubling or quadrupling the angular resolution encountered at a given observation distance from the aperture plane.
Consideration for Virtual Images at Different Depths, Regarding Angular Resolution:

The desired Virtual Display Depth Range should also be taken into account when structuring the angular resolution pattern for a scanning aperture display implementation. Virtual objects set in intersection or near the aperture plane make the most efficient use of angular resolution, and are least likely to encounter stereoscopic breakdown. Stereoscopic breakdown is most likely to occur in two broad situations: 1) The observer is near the screen and a virtual object is constructed to appear ‘deep’ behind the aperture plane; and 2) The observer is at a distance from the screen and a virtual object is constructed to ‘protrude’ a significant distance from the aperture plane.

The most successful remedy in both cases is to design for an increased angular resolution over the desired viewing range. It should be noted that the simplest way to increase angular resolution is to decrease the maximum viewing angle of the display. Notice in FIG. 3 that the angular resolution over the entire viewing range at a radial distance from the aperture is greatest near the extremes in viewing angle, and least in the middle. For displays with extremely wide viewing angles, this effect makes it inefficient to increase the angular resolution, as most of the increase occurs at the extremes of the viewing range.

Calculating Angular Resolution

Provided below is one useful method for determining the minimum angular resolution experienced by an observer moving through the entire viewing range at a fixed radial distance from a given aperture.

The Angular Resolution Measured Minimum (ARmin) can be found at a viewing angle normal to the aperture (See FIG. 4).

$$AR min = \frac{G}{dP}$$

The ARmin is useful when designing a system because it allows engineers to quickly identify angular resolution deficiency (being AR's less than 31 discreet angles per meter). It can not, however, be used to determine the angular resolution of a display at the extreme ends of its viewing range
Visual Constraints with Scanning Aperture Hologram Displays

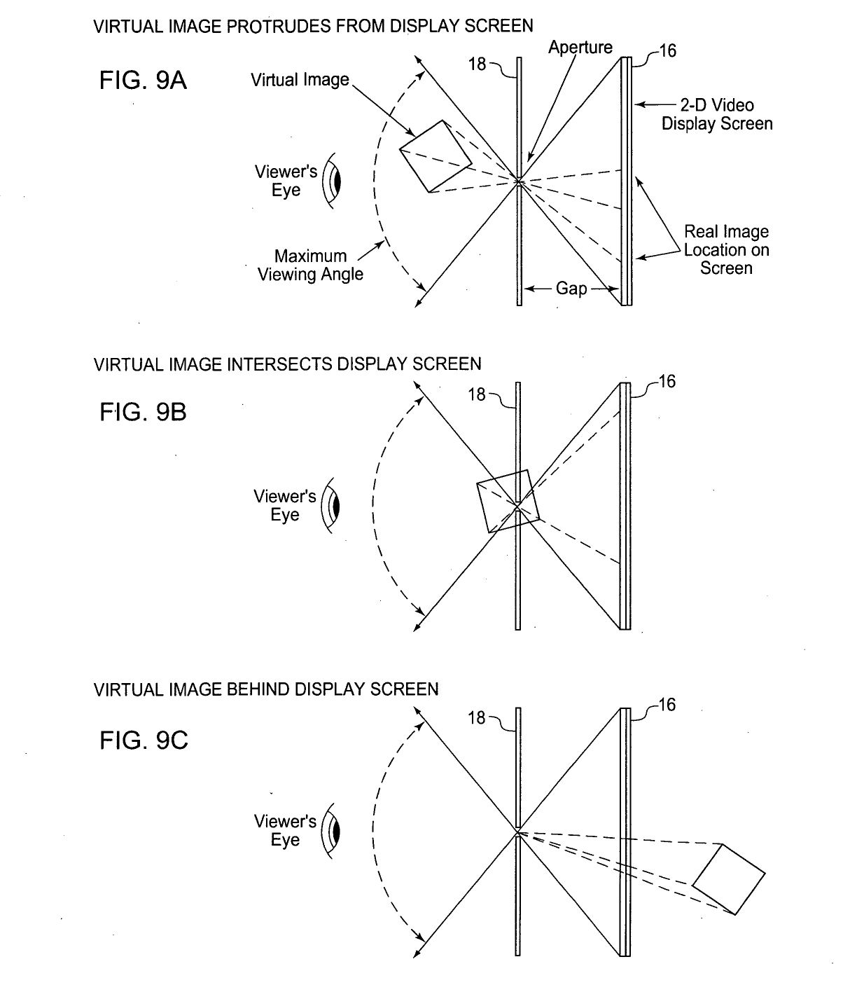

Objects displayed through a scanning aperture display device may be viewed over a wide range of angles by simply changing viewpoints by repositioning the head (eyes) in the real world. Objects presented on the screen can be mapped in such a way as to appear behind the plane of the screen, in intersection of the plane, as well as in front of the plane. (See FIGS. 9a-9c) The image is constrained in that plane of the screen fully defines the area in which the image may be formed. In other words, images seen on the screen may be seen to extend both behind and in front of the screen's surface, but no image can be formed outside the screen's edges.

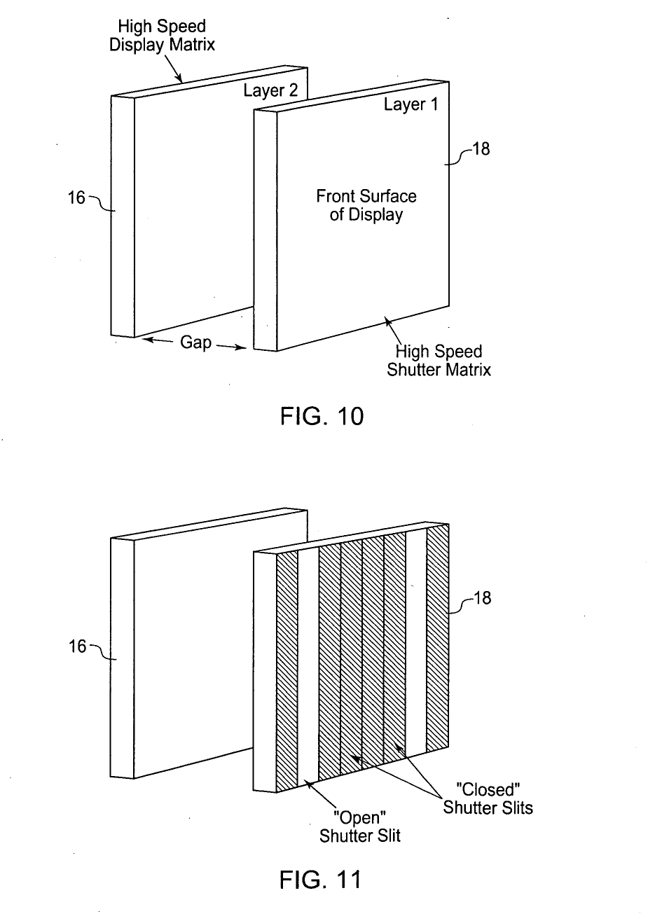

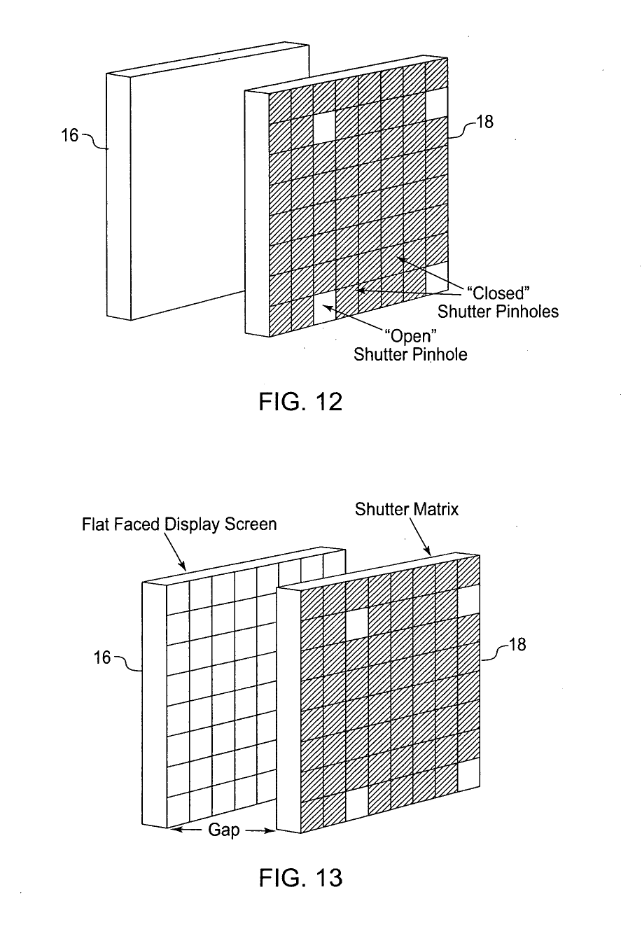

FIG. 10 shows as basic representation of the scanning aperture 3D image display system according to an embodiment of the invention. As shown, the system includes of a matrix of high speed shuttered apertures (Layer 1), i.e., aperture plate 18, a gap G of a specific length, and a high speed video display matrix (Layer 2), i.e., display 16. In one embodiment, the aperture plate 18 is a high-speed optical shuttering system, employing high-speed liquid crystal or other birefringant optical shuttering technology. Its ‘shutters’ are numerous and are arranged as either narrow vertical columns (See FIG. 11) or as a matrix of fine rectangular windows (See FIG. 12).

As discussed above, a precisely maintained gap G separates the aperture plate 18 and the display 16. The gap G is preferably greater than the width of one ‘shutter’ and less than the entire width of the first aperture plate 18. Most preferably, the gap G will be in a range of 0.1 cm to 5 cm, according to various embodiments of the invention.

The display 16 is preferably a high frame-rate video display device, and may employ any of a variety of display technologies. Examples of these technologies would be: High-speed liquid crystal display technology or Ferroelectric liquid crystal display (FLCD); Organic LED technology; Miniature LED technology, plasma, zero twist nematic LC; rear projection using multiple projectors or a DLP mirror chip (described below); or a hybrid projection system based on the combination of any of these technologies. Preferably, the pixels on the display screen are not wider than the width of any single ‘shutter’ on the aperture plate 18.

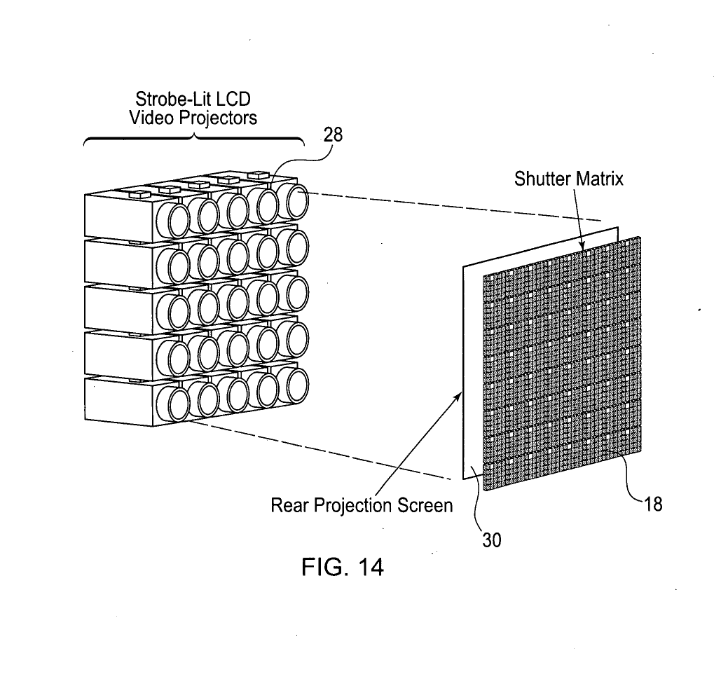

FIG. 13 shows a flat faced display screen that can be implemented using any one of the plasma, FLCD, LED, OLED or LCD display technology. FIG. 14 shows a rear projection hybrid system using multiple LCD video projectors back lit by sequenced strobe lights being used as an alternative to a single high-speed display screen 16.

According to one preferred embodiment, the display screen 16 is capable of producing a sustained display frame rate between 150 and 10,000 frames per second. A suitable example of such high speed video display screen used for the proposed purpose of parallax reconstruction in the 3D display system of the invention will use a Smectic C-Phase Ferroelectric Liquid Crystal as its electro-optic medium.

In accordance with one aspect of the invention, the scanning aperture 3D display device receives its input from a digital image source, such as a computer, disk array, or a solid-state data buffer. The device is electronically driven by specialized, self-contained driver circuitry. The driver circuitry is capable of formatting a 3D data input for holographic viewing in real time. Input file types may include common 3D codecs such as DXF, STL, LWO, XGL, and VRML. Input sources will vary according to application. Applications include medical, industrial, commercial, scientific, educational, and entertainment related viewing systems.

Two-Axis System

A two-axis 3-D display system differs structurally from the aforementioned one axis system most noticeably in the shape of the parallax barrier active regions, here forward referred to as apertures. Each aperture is a transparent region of the ‘aperture plate’, which rapidly translates across the face of the aperture plate. In the one-axis system, the aperture is preferably vertical ‘slit’ with a width matching the width of pixels of the display screen, and a height running the entire height of the aperture plate. In a two-axis system, aperture dimensions will ideally match the respective dimensions of each pixel of the display screen. Further, the total number of active regions on the aperture plate will be less than or equal to the total number of pixels on the display screen.

Eliminating Frame Vignetting

Most commonly, the aperture plate and display screen sizes will be equal, but it may be desirable for some applications to extend the display screen's edges beyond the edges of the aperture plate, both horizontally and vertically. The effect will be to eliminate the otherwise inherent ‘inset frame’ effect seen around the edge of the one or two axis systems. This effect will cause a dark vignette to form at the edges of the screen when looking into the screen from off-normal angles. The apparent thickness of this vignette approaches the width of the gap G between the aperture plate and the display screen. For high-resolution displays of fewer than 100 discreet angles, the effect will be minimal. The effect will, however, become more noticeable if a large number of discreet angles is called for, or should a narrower maximum viewing angle be desired. (Both these conditions contribute to a widening of the gap between the aperture plate and display screen, and hence a thickening of the outer frame. Should one choose to eliminate the ‘inset frame’ effect, one should make the display screen wider than the aperture plate by a number of pixels equal to the total number of discreet horizontal angles to be presented, and taller than the aperture by a number of pixels equal to the total number of discreet vertical angles to be presented. The size-increased display screen is then centered behind of the aperture plate, at the appropriate gap distance. If this technique is applied to a single axis system, the width of the display screen should be increased by a number of pixels equal to the total number of discreet angles, and the height may be increased by the same number of pixels. The display preferably will be centered behind the aperture plate.

Frame Rate, Discreet Angle Allocation, Compromised Views

Two axis systems require substantially more discreet viewing angles than single axis displays. The total number of discreet angles (A) required is equal to the product of the number of desired horizontal angles (h) and the number of desired vertical angles (v).
A=hv
The required display frame rate is given as the product of the total number of discreet angles (A) by the minimum fps required to overcome visible flickering (generally between 20 and 30)
r=20A

The 2-axis implementation may have a different number of vertical angles than horizontal angles. This is advantageous because, for an upright display screen, most user motion and depth perception occurs in the horizontal direction. The number of vertical angles should, however, be a reasonably large fraction of the total number of angles. For example, to place 100 angles along the horizontal axis and only 12 on the vertical axis requires 1,200 discreet angles, running at a frame rate of 24,000 fps. This is a very high frame rate, requiring an aperture optical response time of 40 microseconds at the longest. Also, the imbalance between the number of horizontal and vertical angles will be reflected by a very narrow maximum vertical viewing angle. This restricts the viewing volume in which a viewer's eyes must exist in order to perceive an uncompromised 3-D view. According to an aspect of the invention, the frame rate of the display device can be in a range 160-10,000 fps.

A compromised view of the display is any view from which the viewer's angle of view to some portion of the screen exceeds that portion of the screen's maximum viewing angle. When using an air-gap separation between the aperture plate and the display screen, a compromised view will resemble a fractured or repeated portion of the current image in all regions seen from an excessive viewing angle. When viewing images on a display having a solid-substrate type gap, a region viewed from too excessive an angle will appear to stretch slightly, beyond which the region will appear as a solid color. This is due to an internal refraction effect, which prevents the transmission of light from angles outside the refractive maximum of the substrate.

Scanning Patterns

Apertures in a two-axis system will be cycled through the total number of discreet viewing angles afforded by the display. To maximize the brightness of the image, it is desirable to have as many apertures open on the screen at a given time as possible. This number is found by dividing the total number of aperture plate pixels by the total number of discreet angles. More specifically, one can find the- total number of vertical columns of open apertures by dividing the total number of horizontal apertures in the aperture plate by the chosen number of discreet horizontal angles. In the same way, the total number of horizontal rows of open apertures is found by dividing the total number of vertical apertures in the aperture plate by the chosen number of discreet vertical angles. If the chosen number of apertures are opened in vertical columns and horizontal rows, and distributed evenly, the result will be a grid of ‘dots’ or open apertures in the aperture plate. In one embodiment, each open aperture can be thought of as defining one corner of a rectangular region of scan.

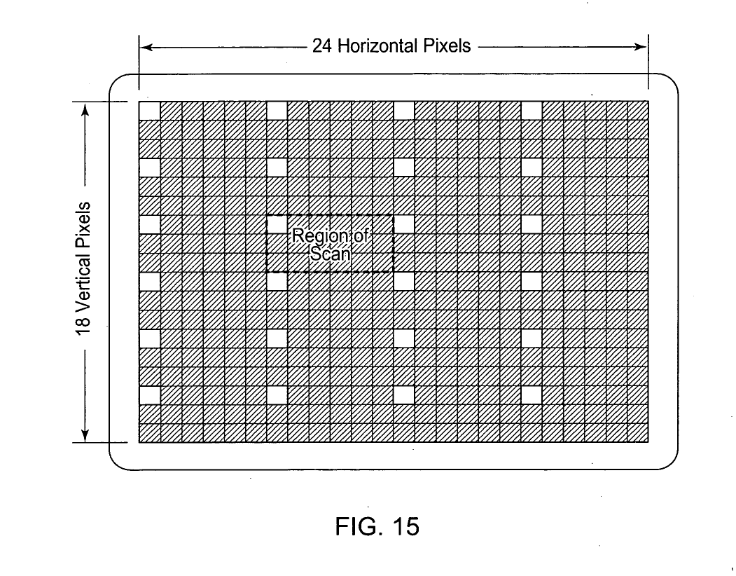

In operation, the aperture plate will translate these open apertures across each small region of scan, line by line, through a number of steps equal to the number of total discreet viewable angle before repeating. In FIG. 15, the display has 18 discreet viewable angles. The pattern of the aperture plate shown in FIG. 15 indicates a rectangular grid. This scanning pattern does not necessarily need to be aligned in this manner. Alternatively, the scanning patterns could be somewhat ‘stair stepped’, or could be completely randomized. The gridded “region of scan” configuration is simply useful organizational tool.

Viewing Volume of a Two Axis 3-D Display System

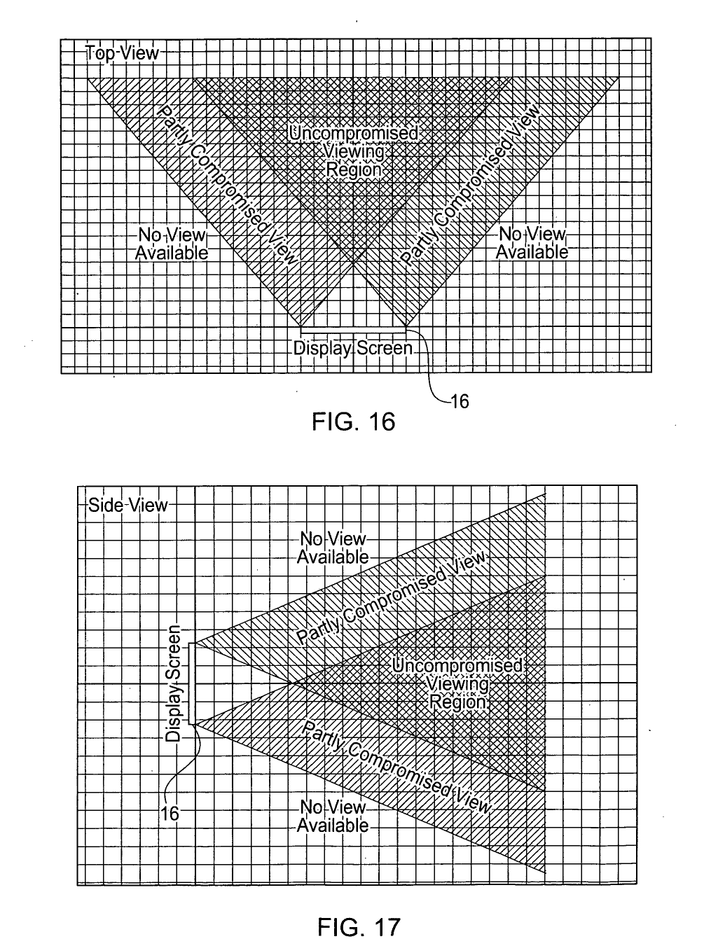

Each of the two axes of the display has a maximum viewing angle away from the normal. By projecting this maximum angle outward from either side of normals extending from the most separated apertures on the aperture plate, it is possible to determine the shape and location of the viewing area for the given display axis. FIGS. 16 and 17 demonstrate this concept. The display screen 16 shown offers a maximum horizontal viewing angle of 40 degrees, and a maximum vertical viewing angle of 22 degrees. The 3D renders of FIGS. 16 and 17, show the 3-dimensionality of the actual uncompromised viewing volume (region). Note that the fully uncompromised region is the volume of intersection between the horizontal and vertical viewing regions.

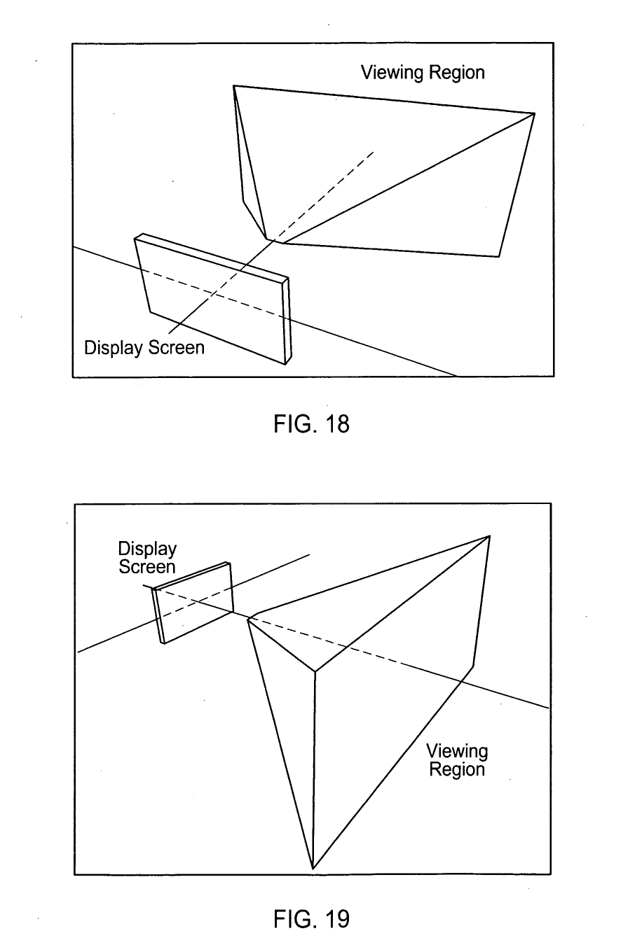

Thus, it is readily understood that any two axis display based on dynamic parallax barrier time multiplexing will have some angular limitations for a given axis, and that, taken together, the total uncompromised viewing volume will have a pyramidal, or wedge-fronted pyramidal shaped volume extending away from the display screen and separated from the screen by a certain distance. The outermost boundary of the pyramid (the reclining pyramid's ‘base”) is determined by the distance at which the screen's 3-D effect breaks down because of reduced angular resolution. FIGS. 18 and 19 depict the uncompromised viewing volumes from various perspectives in accordance with the two-axis 3-D display systems of the present invention.

Solid State System

As described in detail above, it is understood that three-dimensional images, having realistic angular parallax over a wide range of viewing angles, can be achieved through time-modulated image reconstruction. This can be accomplished by the use of dynamic parallax barriers (scanning apertures) in conjunction with a step-synced video display device separated at a defined distance or gap G. The following embodiments show the implementation of this technique which involve a ferroelectric liquid crystal matrix (FLCD) as a dynamic parallax barrier, and a high speed video display (e.g., FLCD) with a high-speed address bus. In practice, the ferroelectric display matrix is placed at a precisely maintained distance (gap G) from the face of the display. Such a system can, under optimal conditions, produce several discreet angles of parallax over a substantially wide range of viewing angles and can, under special circumstances, achieve color.

Under ordinary circumstances, however, it is difficult, if not impossible, to produce reliable color, brightness, and resolution at the high frame rates required by the 3D display system of the present invention using old CRT technology.

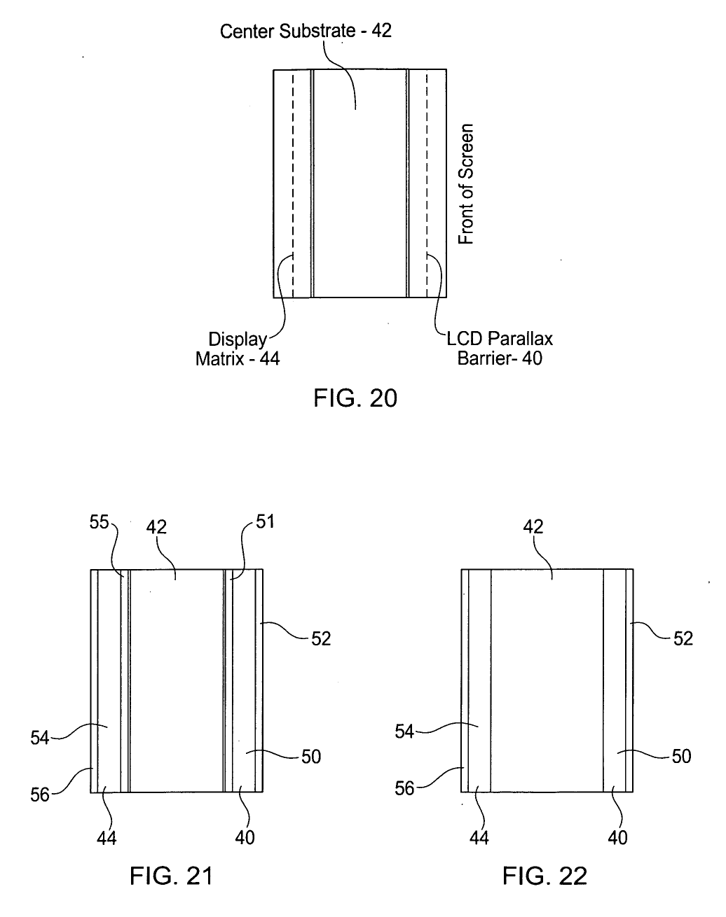

FIG. 20 shows a solid state version of the scanning aperture 3-D display system according to another embodiment of the invention. This embodiment provides a method and structure for creating a truly solid-state, high resolution, three-dimensional color display device capable of realistic angular parallax over a wide range of viewing angles comprising, by way of example, a liquid crystal dynamic parallax barrier 40 (e.g., FLCD), a transparent substrate of a specific thickness and index of refraction 42, and a high speed liquid crystal (e.g., FLCD) or OLED display matrix 44.

This solid state embodiment will have the following features: 1) no air gaps or open regions within its volume; 2) capable of producing images in realistic color and of high resolution, having pixel pitches between 1 mm and 0.25 mm; 3) capable of producing multiple viewing angles; more than 8; 4) includes a solid transparent substrate onto opposite faces of which are bonded a liquid crystal dynamic parallax barrier and a high-speed flat display matrix; 5) display is capable of a relatively wide viewing angle, maximally 90 degrees from normal for a given axis; and 6) display uses a solid-state display device capable of sustained high frame rates between 200 and 10,000 frames per second.

The display device is comprised of three solid layers. The outermost layer, facing the user, is a solid-state dynamic parallax barrier 40. This can be a high-speed LCD matrix (e.g., FLCD), alternately, it could use Zero-Twist Nematic liquid crystal technology. The second layer is the central substrate 42, a preferably low-density transparent material of precisely chosen thickness and refractive index. The substrate can consist of fused silica glass, acrylic, or other optical material having a suitably low index of refraction. The third layer is a solid-state display matrix 44. This may be a transmissive-type display formed from high-speed LCD technologies, which can include ferroelectric or ZTN, or can be of an electroluminescent type, such as organic LED (OLED) or plasma. According to a preferred embodiment, FLCD is used for matrix 44.

The LCD parallax barrier 40, as mentioned above, will consist of a liquid crystal matrix over whose face is an array of discreet active regions which can, by the application of electrical current, switch from being opaque to transparent, and return to opaque with the removal or reversal of said electrical current. These active regions may, in one embodiment, be shaped like tall rectangles, having width equal to or slightly larger than that of an image pixel of the display matrix, and having height extending vertically from the lowest edge of the display screen's active area to the upper most edge. This configuration will allow the construction of images having realistic angular parallax, but only in the horizontal direction. Alternately, the active regions of the parallax barrier can be rectangles whose height and width are nearly equal. This configuration will allow the display to produce images having angular parallax in both the horizontal and vertical axis. In operation, the active regions of the parallax barrier are rapidly activated in sequence so as to emulate several scanning slits or an array of pinholes. These virtual optical apertures are made to translate at a rate rapidly enough that the translation cannot be detected by the human eye.

The required optical response time for said dynamic parallax barriers is given as:
T=1/(20*v*h)
where T is the optical response time, v is the number of vertical angles to be presented, and h is the number of horizontal angles to be presented. The preferred embodiment includes a dynamic parallax barrier 40 that can sync to a video image from display 44 with a frame rate between 160 and 10,000 frames per second. To meet these requirements, the active material in the dynamic parallax barrier 40 (e.g., smectic C-phase ferroelectric liquid crystals) must have optical response times between roughly 3 milliseconds at the slowest and 5 microseconds at the fastest.

The number of transparent active elements that are open at any given moment during the parallax barrier's operation is given as by the following equations:

For slit-type configuration:
a=Rh/h
where a is the total number of open slits, Rh is the horizontal resolution of the display screen, and h is the total number of discreet horizontal angles to be presented.

For pinhole-type configuration:
a=(Rh/h)*(Rv/v)
where a is the total number of open slits, Rh is the horizontal resolution of the display, h is the total number of discreet horizontal angles to be presented, Rv is the vertical resolution of the display screen, and v is the total number of discreet vertical angles to be presented.

The transparent substrate 42 is positioned directly behind the parallax barrier 40, and generally comprises a single layer of transparent material of suitable thickness and refractive index. This layer acts, at least in part, as the structural base for both the dynamic parallax barrier and the display matrix layers. These layers preferably are bonded to the substrate layer by means of a transparent adhesive, such as an optical epoxy or resin. Other adhesive methods may include clearwelding using lasers having a specific bandwidth and absorbing dyes in the substrate or parts being bonded thereto that do not interfere with the optical properties of the substrate 42 (i.e., dyes capable of absorbing the laser light energy in the predetermined bandwidth and in response to the absorption of the laser energy, completely bonds-the two surfaces without any change in the optical properties of the bonded surfaces).

The substrate 42 preferably has uniform thickness, and refractive index over its entire area. The substrate may or may not polarize the light that passes through it. The substrate may or may not affect the color of the light that passes through it by means of dye or other subtractive chromatic filter.

According to other embodiments, the substrate 42 can be implemented as part of either the parallax barrier (aperture plate) 40 or the display 44, or both. FIGS. 21 and 22 show various different solid state embodiments of the present invention.

FIG. 21 shows the parallax barrier (aperture plate) 40 having three layers, two glass layers 51 and 52 and an LCD layer 50 between the two glass layers, while the display 44 also has three layers, two glass layers 55 and 56 and an LCD layer 44 disposed between the two glass layers. As shown, in this embodiment, the glass layer 51 of parallax barrier 40 is adhered to the substrate 42 in any suitable known manner, and the glass layer 55 of the display 44 is adhered to the substrate 42 in any suitable known manner.

According to another aspect of the invention shown, the respective glass layers 51 and 55 of the barrier 40 and display 44, respectively, are eliminated and replaced by the substrate 42. FIG. 22 shows an example of this embodiment where the display 44 and parallax barrier 40 are integrated with the substrate in one single piece structure.

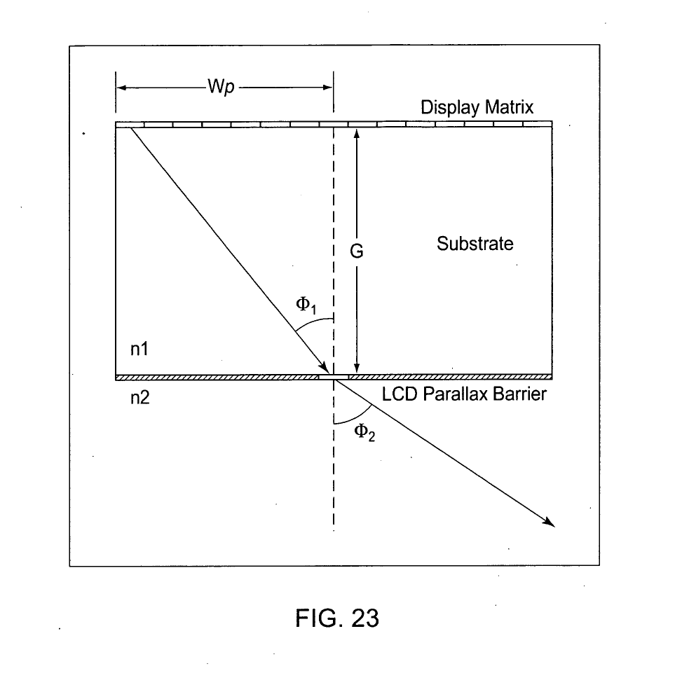

FIG. 23 and the following set of equations describes the relationship between the thickness of the substrate 42, its index of refraction, and the maximum viewing angle away from normal for a given display 44.

FIG. 23 shows a cross section of an exemplary implementation of the invention. Notice that the maximum viewing angle away from normal (Φ₂) is a function the partial projection width (Wp), the thickness of the substrate (G), and also the refractive indices of the substrate and viewing environment (n1, n2). The calculated value of Wp is given below:
Wp=PA/2
where Wp is the partial projection width shown in FIG. 21, P is the width of a given pixel on the display matrix, and A is the total number of discreet angles to be constructed by the particular display. The maximum viewable angle away from the normal for a given display is given as the following:

$${Φ}_{2} = arcsin ( \frac{n1 Wp}{n2 \sqrt{{Wp}^{2} + {G}^{2}}} )$$

where Φ₂ is the maximum viewing angle away from normal, n1 is the substrate refraction index, Wp is the partial projection width, n2 is the refraction index of the viewing environment (most likely air) and G is the thickness of the substrate. It must be noted that the above equation describes the viewing angle with respect to the substrate's index of refraction, but that the absolute maximum viewing angle for a particular display will be intrinsically limited by the substrate's index of refraction. Beyond a certain maximum Φ₂, the rays of light from the display screen will be subject to complete internal reflection within the substrate. The above equation was evaluated for several candidate optical materials with the following results:

| Material | n | Degrees Max. Viewing Angle |
|---|---|---|
| Fused Silica | 1.46 | 42 |
| Acrylic | 1.49 | 41 |
| Optical Glass | 1.51-1.81 | 41-32 |
| Polycarbonate | 1.59 | 38 |

From the above data, it becomes clear that lower n values for a given substrate material result in a greater maximum viewing angle. By selecting the proper substrate material, it is theoretically possible to create displays with maximum viewing angles of greater than 45 degrees. Even an angle of 40 degrees from normal (80 degrees total viewing angle) is acceptable for most applications, and is acceptable for viewing by multiple persons.

The thickness of the substrate will remain relatively thin for displays of standard video monitor resolution and relatively moderate number of discreet angles. With a pixel pitch of 0.3 mm and 100 discreet angles, the substrate will most likely be under 2 cm thick. For higher numbers of discreet angles, the substrate becomes thicker, but not unmanageably so. An extremely high angle display capable of reconstructing 500 discreet angles, having a pitch of 0.3 mm will require a substrate roughly 8 cm thick. Most practical embodiments, however, will fall in the 50-150 discreet angle range, and will be less than 2 cm thick. A minimum thickness 3-dimensional display, capable of reconstructing just 8 discreet angles, and backed by a display with 0.25 mm pixel pitch, only requires a substrate thickness of 2 mm.

It should be noted that, especially in the case of small to moderate numbers of discreet angles, and for display systems of very small thickness, a precisely maintained separation between the parallax barrier and display matrix is critical. The use of a transparent substrate is the most practical method for setting and maintaining such a geometrically perfect separation and alignment.

The high-speed display matrix 44 is the back most layer in the solid state 3-dimensional display system. It is comprised of roughly rectangular pixels, having height nearly equivalent to width, as in a standard LCD screen. In a liquid crystal embodiment, the display screen preferably would employ either high-speed ferroelectric liquid crystal, or moderately high speed Zero-Twist Nematic liquid crystal technology, or any of a variety of other suitably fast bi-refringent liquid crystal materials (e.g., smectic C-phase ferroelectric liquid crystals). The display will employ commonly practiced techniques for implementing full color production.

In one electroluminescent embodiment, the display matrix comprises one or several layers of organic light emitting polymer. The matrix is capable of producing any of a broad spectrum of colors of light from any of its pixels, and is capable of maintaining the high required frame rate. A third technology is that of plasma display, where an array of electrodes causes a gas to emit light, illuminating a matrix of fluorescent segments. This method can theoretically produce the required frame rates, but is least desirable because it requires expensive encapsulation techniques and is somewhat more fragile than the other two.

The pixel pitch of the high-speed display is comparable to standard video displays, between 1 mm and 0.25 mm in size. The pixel and parallax barrier pitch will ideally exist within this range, as images become highly course when pitch exceeds 1 mm, and unwanted chromatic diffraction effects become apparent at pitches below 0.25 mm.

The screen is capable of refreshing the entire surface of its display once for each configuration of the dynamic parallax barrier, between 150 and 10,000 times per second. In operation, the refreshing of the display screen and the parallax barrier are synchronously locked to one another.

The three-dimensional display screen is innately backward compatible as a standard monitor. In standard monitor mode, all of the active regions in the dynamic parallax barrier 40 are made to be transparent, while the rear display screen 44 is made to display video at a standard frame rate, at standard resolution.

The solid state system disclosed in FIGS. 20 and 21 can be manufactured using existing glass-on-glass processes used to produce standard LCD panels of large size. This enables the manufacture of large sized high-resolution screens.

During manufacturing, the parallax alignment of the display screen (matrix) 44 is intrinsically maintained by the system, as the dynamic parallax barrier 40 and display screen 44 are firmly bonded to the substrate 42. The substrate, being of a precise thickness, rigidly maintains the separation regardless of vibration, pressure differential, or flexure.

An advantage to the solid state embodiment herein is that the system is compact and robust. Since the system of the preferred embodiment incorporates a flat-panel display matrix comprising high-speed liquid crystal technology (e.g., Ferroelectric or Zero-Twist Nematic) or an electroluminescent display system (e.g., OLED, LED), the complete display system is not bulky or susceptible to magnetic interference or vibration like CRT technology.

Some of the unique attributes of the proposed solid state flat-screen scanning aperture hologram (3D) display device of the invention include: 1) No spinning mirrors prisms or moving parts involved in the imaging system; 2) No lasers utilized to produce holograms; 3) Displays images in full color; 4) Requires no special glasses for viewing; 5) Produces realistic angle-dependent perspective, i.e., the image is a true hologram; 6) Can accept a standard digital input; is compatible with a variety of devices; 7) Can emulate other display technologies: stereoscopic, 2D standard display; 8) Images are not bounded like a volumetric display; can appear to protrude from display; 9) Requires a lower signal bandwidth than other developing holographic display systems; 10) Offers more flexibility of design in terms of size, viewing angle, and brightness than other developing holographic display systems; 11) Utilizes well-understood electro-optical phenomenon, does not rely on quantum-effect based technology; and 12) Can be produced at lower cost than laser-based systems, using existing fabrication techniques.

Other Possible Uses and Variations:

The 3D display device of the present invention can be used to display data from medical imaging devices such as NMRI, CAT scan, PET scan, and 3D Ultrasound. In practice, it would enable doctors to actively view a patient's organs in a realistic 3-D perspective.

The device can also be used as a display for industrial design applications, including automotive and product design. A wall-sized variation of this display could enable engineers to inspect a life-sized model of a new car before it is physically constructed. Multiple display screens may be arranged to form a cylindrical display arena, which would enable viewers to walk around a displayed hologram. As an alternative to this arrangement, a horizontal display table will enable viewers to walk around smaller scale holograms. Such displays could be combined with manual input devices using haptic technology to let engineers interact directly with holographic images. Smaller displays could be used by product developers to demonstrate project designs to clients. Wall mounted holographic display could be used for advertising, or as ‘virtual windows’ in otherwise cramped apartments. Wall mounted displays may also be very useful in educational institutions such as museums and art galleries, as they could reproduce the appearance of various precious artifacts, works of art, extinct animals, or other difficult to observe items.

Those of ordinary skill with recognize that various hardware may be utilized for different component parts of the disclosed 3-D display system without departing from the spirit of the invention. The following represents an exemplary list of equivalent structures that may be implemented into the system of the invention:

I. Scan Type

Scan type describes the means by which an aperture is rapidly translated across a viewer's field of view. This is necessary to the formation of complete images from otherwise pinhole or slit like apertures.

A. Solid State scanners are the most desired class of aperture scanners for commercial scanning aperture holographic displays. Their key distinction is they use not moving parts in the process of aperture translation.

1. Flat solid-state scanners are comprised of a dense matrix of liquid crystal or similar light shutters that can be rapidly made to shift between opaque and transparent. They can most easily used to create rectangular flat-screen type displays desired by the computer industry. Ferroelectric liquid crystal optical shutters have been found to have a suitably fast response time.

2. Curved solid-state scanners describe a system identical to the flat type scanner above, but built on a curved or flexible substrate. This type may be more difficult to achieve, but can be used to create cylindrical or otherwise unusually shaped displays. Applications include immersive VR environments, public display systems, and ‘artificial transparency’ whereby an opaque object is clad with holographic displays and made to appear transparent.

II. Aperture Type

A. Slit type apertures consist of a vertical aperture with the height of a given display screen and generally having the width of a similar size as the width of a single pixel of the display screen. This is the simplest scanning aperture configuration, requiring the lowest frame rate and electronic signal bandwidth. It is limited in that it only produces horizontal perspective. (A viewer may view the left and right side of a holographic object, but will not be able to see the top or bottom of the object.) This display is well suited for low cost systems used with gaming, entertainment, and design related applications. It may also be perfectly suitable for industrial, medical and military applications. In all configurations, the screen must be oriented upright to the viewer, as a computer monitor or easel, as opposed to a tabletop.

B. Pinhole type displays' apertures are small and rectangular or radially symmetric in shape. This class of display type is capable of producing accurate perspective in both the horizontal and vertical directions. Though this requires up to the square of the slit-type displays' bandwidth, such displays are suitable for table type systems. Table type systems consist of a display oriented parallel to the plane of the floor. They may be viewed from anywhere around the display, and are generally seen by looking down onto the display's surface. Such displays are ideal for engineering, design, and architectural applications. They may also be useful for certain medical applications such as virtual or telepresence surgery. Military applications may include tracking troop movements above a three-dimensional satellite map of the battlefield. Entertainment systems include arena type displays for viewing sporting events from many different angles, as game pieces on a table.

III. Display Type

A. Direct display screens in scanning aperture displays are display systems whose active elements are placed directly behind the aperture plate, as set off by the gap. This class of display is best used to thin-screen holographic displays, suitable for laptop computers and portable equipment. Display may be limited in frame rate, and hence in angular resolution produce because of the display technology's innate response time.

1. Plasma displays are capable of producing suitable fast frame rates and brightness levels, but are rather expensive. Plasma displays are generally a screen comprising a grid of electrodes within an encapsulated volume. The electrodes selectively cause the gas to fluoresce, emitting visible light or stimulating specific color phosphors to emit light.

Plasma displays are not as bulky as other types of displays and can be built as flat, thin screens, and have been shown to exhibit excellent color, and are capable of the required high frame rates. However, Plasma displays exhibit some limitations with respect to resolution, and still require a potentially fragile sealed glass enclosure.

2. OLED or Organic Light Emitting Diode technology is emerging as a highly efficient display technology. OLED comprises a matrix made up of cells of an organic electroluminescent material that emits light of a specific color when an electric current is applied. Such displays may be capable of excellent brightness and color and power conservation.

OLED display matrices promise thin, flexible, color display screens that are capable of both high resolution and fast frame rate. OLED displays are currently being incorporated into small portable devices because of their power efficiency and high-viewing angle characteristics. OLED is, perhaps, the natural direction toward which future displays will tend

4. LCD or Liquid Crystal Displays are a matrix of small cells containing crystal particles in liquid suspension and which are re-oriented by an electric field, causing a shift in polarization, which switches light passing between a pair of polarizing filters.

LCD technology is the natural choice for portable high-resolution color video display systems. They have a low power requirement, are naturally very flat in construction, and are manufactured by a wide industry base, making them relatively inexpensive. Standard TFT LCDs are typically limited in their optical response time, which is typically in the range of 1 to 200 milliseconds or longer. This switching rate is not high enough for use in a Scanning Aperture 3-D display system, which optimally requires optical switching times well below 1 millisecond.

This is generally true of most families of liquid crystal materials. There is, however, a narrow class of liquid crystals that seems perfectly suited to high frame-rate operation: Smectic C-Phase Ferroelectric Liquid Crystals. This class of liquid crystals demonstrated as optical switches with response times ranging from 5 to 150 microseconds, or roughly three orders of magnitude faster than standard LCDs.

5. Ferroelectric LCD (FLCD) displays are perhaps the most suitable technology as it can be made to match the response time of the previously discussed solid-state aperture scanner. A more detailed discussion of FLCDs and their application to the present invention is discussed in greater detail below.

B. Rear projection type displays are suitable for lower cost displays that can be built to fit in cases similar in proportion to Cathode Ray Tube (CRT) video displays. They may also be initially the most economical way to produce the excessively high frame rates required for scanning aperture display systems.
1. High speed video projectors have already been developed for use in volumetric 3-D display systems, and may be configured to produce suitably high frame rates for scanning aperture holographic systems.
2. DLP or Digital Light Processing is an integrated circuit matrix of micro- electro mechanical mirrors used to redirect a strong light source to form an image on a display screen. Some DLP displays are rear projection based.

DLP projection systems offer the advantages of high brightness, excellent color, and high frame rate. They are most commonly used in high-resolution video projection systems, and are a proven technology. They are, however, somewhat expensive, and are innately a projection technology. This limits their use to larger format rear-projection and theatrical-type projection systems; they are not suitable for most portable or compact display applications, such as laptop computers.

3. Hybrid, or compound video projection systems use several lower frame rate projectors in tandem with shuttered outputs in order to produce a suitably high frame rate. This configuration may be unnecessarily complex to align and calibrate. The main advantage is that it utilizes already existing LCD or DLP technology.

Ferroelectric Liquid Crystals (FLC)

Like the more common classes of twisted nematic (TN) liquid crystal materials, the crystal suspension used in FLC displays exhibits a chiral, or twisted molecular orientation when mechanically and electrically unconstrained. In practice, though, a Ferroelectric Liquid Crystal Display (FLCD) differs from a standard TN or STN (Super Twisted Nematic) LCD in a few important ways.

Surface Stabilization

In the construction of an STN display cell, the liquid crystal suspension is sandwiched between two glass substrates that have been surface treated or ‘rubbed’ with a particular pattern that causes the suspension to align its chiral structure in an ordered way. The substrates can be separated by several dozen to several hundreds of microns, depending on the specific application and desired switching characteristics. Thus, there is some room for inconsistencies in the substrate separation.

In contrast, a ferroelectric liquid crystal suspension must be carefully surface stabilized to its glass substrate. It must be held to a thickness of 1 to 2 microns, which must be evenly maintained over the entire area of the display's active region. This separation is maintained by the introduction of small spherical, optically inactive, spacer particles of the desired diameter. This need for precision makes the production of FLCDs more expensive than standard TFT, and the displays are more susceptible to damage due to flexure of the glass substrate. These limitations, however, have largely been overcome by manufacturers.

Driving System

A standard LCD of the STN or TN variety may be driven either as a passive or active matrix display. Passive displays have electrodes running in the vertical and horizontal direction oriented on either side of the LCD suspension. Pixels of the LCD can be addressed by directly passing current between specific electrodes, which cross at specific regions. An inherent disadvantage to this addressing technique is that, as the number of pixels to be addressed increases, the contrast ratio between activated and not-activated pixels diminishes. This limits passive matrix displays in both their resolution and their optical response time. Larger, color STN displays commonly make use of an active matrix addressing system which uses thin transistor film technology (TFT). In a TFT addressing scheme, each pixel of the LCD is backed by one or a few transistors that are integrated directly with the glass substrate of the screen. The transistors act to amplify and switch signals sent through the bus grid to specific pixels, greatly enhancing the contrast of the overall display. The frame rates of STN LCDs are high enough to display full motion video with minimal lag. Like a standard CRT, however, the refresh rate of a TFT must be maintained above 20 to 30 Hz (typically 60 to 80 Hz) in order to prevent visible flickering.

A Ferroelectric LCD can, in theory, operate in the passive matrix mode at extremely high resolution without suffering the contrast limitations inherent in TN or STN technology. This makes it potentially less expensive to produce because it does not require the expensive and complex deposition of a TFT matrix. As an added advantage, an FLCD is free of the cyclic flickering that can be found in STN displays run at too low a frame rate. This is so because FLC maintains its optical state once set, allowing each pixel to act as a kind of direct memory until it is refreshed for the next incoming frame. By way of example, the Canon 15C01 FLCD operates flicker-free with a passive matrix at standard television refresh rates.

Duty cycle

STN or TN LCDs have duty cycles at or near 100%, meaning that each optically active region can be operated in a desired mode (activated or not) without the need for a special reset process. An activated region becomes deactivated by simply removing the electrical field from the electrodes in contact with that region.

FLCD is somewhat unusual with respect to duty cycle. Because the ferroelectric liquid crystal has a state memory, it must be electronically reset to a state (it does not return to an ‘off’ state when current is removed). Additionally, it is harmful for FLCs to be exposed to a net direct current over time. Simply put, for every period of time an FLC is given a positive charge, a negative charge must be given to that region for an equal amount of time. This relationship can be described as a voltage-time product balance, where the product of voltage and time for a positive charge must equal the product of voltage and time for a negative charge. It can also be described as a 50% duty cycle, saying that half of the FLC's cycle can be used towards image formation, while half is required to maintain the liquid crystal. FLCDs are typically run through several hundred to several thousand cycles per second. There are a variety of techniques employed to deal with the inherent 50% duty cycle of FLC in the formation of a light-switch or a display screen. The main methods are as follows:
1) Voltage-Time Product Balancing—The time spent in the recycling-state of the FLC is such that it is less than the desired display state, and the voltage spent in the shorter period of time is inversely increased so that the time-voltage product is maintained. This allows the contrast to be maintained, and also allows for the 50% duty cycle.
2) Dual Layer Approach—two FLCs are layered, one against the other. Each maintains a 50% duty cycle. A pixel of the screen is made to be opaque by selectively rotating the phase of the duty cycle of a pixel in one of the layers in the FLC. In this way, a constant contrast can be maintained, though the elements of the display are continuously reversing their states.
3) Backlight Modulation—The backlight behind an FLCD or other transmissive type display screen of suitably fast refresh rate can be rapidly modulated in brightness so that it illuminates the screen only during the appropriate time in the FLC refresh cycle. This approach requires a backlight capable of rapid modulation, such as an LED or strobe light.
   Color

The most common approach to displaying color with a standard STN display makes use of a deposited patterned layer of dye. Each LCD pixel can thus transmit a single color, red, green, or blue. Pixels are arranged in triads, which are coordinated in their emission to mix these three primary colors into a perceivable total spectrum of color. This is known as a spatially modulated color approach, and by way of example, is utilized by Canon in their FLCD monitor. A less common approach, often used with higher-speed, is the time modulated approach. Three or more elementary colors of light are cycled over a brief time period behind the LC matrix. The matrix consists of simple light-valves, which are then made to transmit the appropriate color by opening only during the appropriate time of the color cycle. This approach, in theory, can yield a display with three times the resolution of a spatially modulated approach. A color modulated backlight, however, is difficult to create for display screens of large size and brightness.

Grayscale

Grayscale performance with FLC has its own separate set considerations. Unlike STN type displays, which can directly achieve gradation based on the applied voltage, FLC is typically high-contrast or nearly binary in this respect. In order to simulate a multi-value transmissive effect, FLC cells can be time-voltage product modulated, or, in a multi-layer system, can be refresh-cycle-phase modulated. It is also possible that some combination of these techniques may be optimal for the desired application.

Temperature

Liquid crystals of the Twisted Nematic type will function over typically a wide temperature range. It is not uncommon for a TN display to have an operating temperature ranging from −15 degrees to as high as 99 degrees Celsius. FLC, however, has a much narrower operating temperature range. FLCs manufactured by Boulder Nonlinear, in Colorado, have an optimal operating range from 20 to 30 degrees Celsius. Canon, however, has widened the operating temperature range of its FLC to be from 15 to 35 degrees Celsius. Even without an extended temperature range, FLC will finction normally in standard room-temperature environment, but may experience a reduction in performance from moderate temperature variances.

According to one preferred embodiment of the scanning aperture 3-dimensional display device of the invention using FLCD; 1) The FLCD screen is capable of producing a sustained display frame rate between 160 and 10,000 frames per second; 2) The high-speed video display screen used for the purpose of parallax reconstruction in the present 3-D display system can use Smectic C-Phase Ferroelectric Liquid Crystal as its electro-optic medium; and 3) The FLC will be surface stabilized between two large-format glass substrates with a total surface area greater than 16 square inches. Maintenance of substrate separation will be accomplished by means of particulate spacers of known diameter, placed between substrates, and surrounded by the FLC suspension.

In the case of the use of a solid central substrate in the Scanning Aperture 3-D Display System (see FIGS. 20-23), the FLC will be stabilized directly to the glass of the thickened center substrate. This configuration offers the following advantages:
1) Simplified overall system design, eliminates unnecessary glass layers;
2) Allows for perfect geometric alignment of FLCD with respect to front-layer aperture plate; and
3) The thickened center substrate (up to 2 cm thick) provides excellent structural support for the somewhat fragile FLC;
4) The FLC achieves color through the spatial modulation technique: A deposited layer of dye is patterned in front of or behind the active FLCD elements. Each pixel can thus transmit a single color, either red, green, or blue. Pixels are arranged in triads, which are coordinated in their emission to mix these three primary colors into a perceivable total spectrum of color. This is desirable over the use of the time-modulated technique because the time dimension will be utilized for the purposes of display-angle multiplexing;
5) In order to simulate grayscale, FLC cells can be time-voltage product modulated, or, in a multi-layer system, can be refresh-cycle-phase modulated. Some combination of these techniques may be optimal for the desired application.
6) The Ferroelectric Liquid Crystal is maintained at a 50% duty cycle. It achieves suitably high contrast by means of time-voltage product balancing, and/or by the use of multiple layers of FLC.
7) The 3D display will operate at room temperature with no special considerations made for the temperature range of the FLCD. Alternately, if the 3D display device is required to operate at low or varying temperatures, a temperature-regulated resistive heating element may be incorporated into the design of the FLCD enclosure. This would be most practical for outdoors or military applications.
8) The FLCD may be driven by a modified passive-matrix configuration. This configuration makes use of the FLC memory, which maintains the optical state of the FLC until the next refresh cycle. The bus system may be configured to allow for simultaneous addressing to multiple FLC cells, allowing for extremely high refresh-rates. The bus system may make use of TFT decoding electronics placed between columns and rows directly on the display screen substrates. Alternately, the column and row decoding electronics may be placed at the periphery of the display screen, or on a separate driver card.

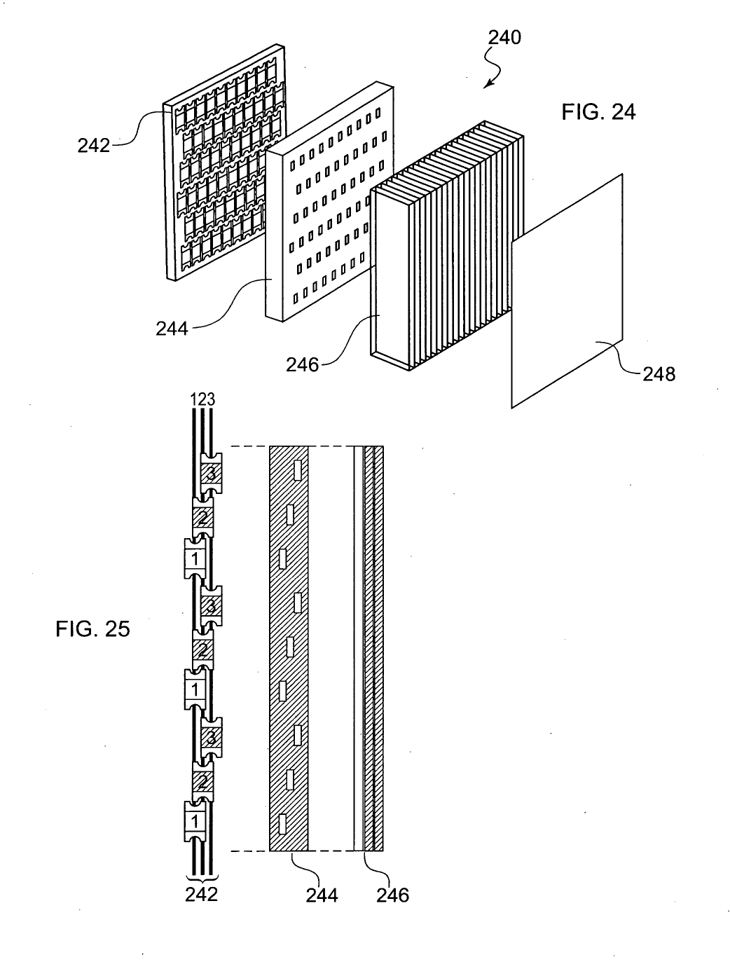

In accordance with these backlight embodiments, the scanning aperture 3-dimensional display device is constructed such that the transmissive display screen is placed in front of a special backlight capable of horizontally scanning vertical columns of light at high speed. Front Screen configured devices make more efficient use of the light produced than the back screen configurations. However, they require a specialized light system to be commercially practical. The following embodiments shown in FIGS. 24-29 describe a commercially practical device for creating a backlight plate having narrow vertical columns that can be sequentially illuminated in rapid succession. The device utilizes solid state LED technology, is scalable to screens of varying size, and is capable of producing columns having widths equal to or smaller than the widths of pixels on a given display screen.

In accordance with one preferred embodiment, the embodiments of FIG. 24-29 use surface-mounted high intensity white LEDs and a novel stacked optical-guide method to produce multiple illuminated vertical columns. The columns are narrower than the LEDs used to illuminate them, and can be illuminated with little to no effect on the immediate neighboring columns. In one desirable embodiment, the illuminated columns will have width equal to that of the width of an image pixel, as displayed on an emissive front-screen. The width, in this case, will be somewhere between 0.5 mm and 0.2 mm. In larger displays, or those having lower resolutions, the width may range from 0.5 mm to several millimeters.

Referring to FIGS. 24 and 25, the system 240 for creating a scanning column backlight for use in the 3-dimensional scanning aperture display device, includes a surface mounted LED bank 242, a mask 244, a plurality of stacked light guides 246 and a diffusive film 248.

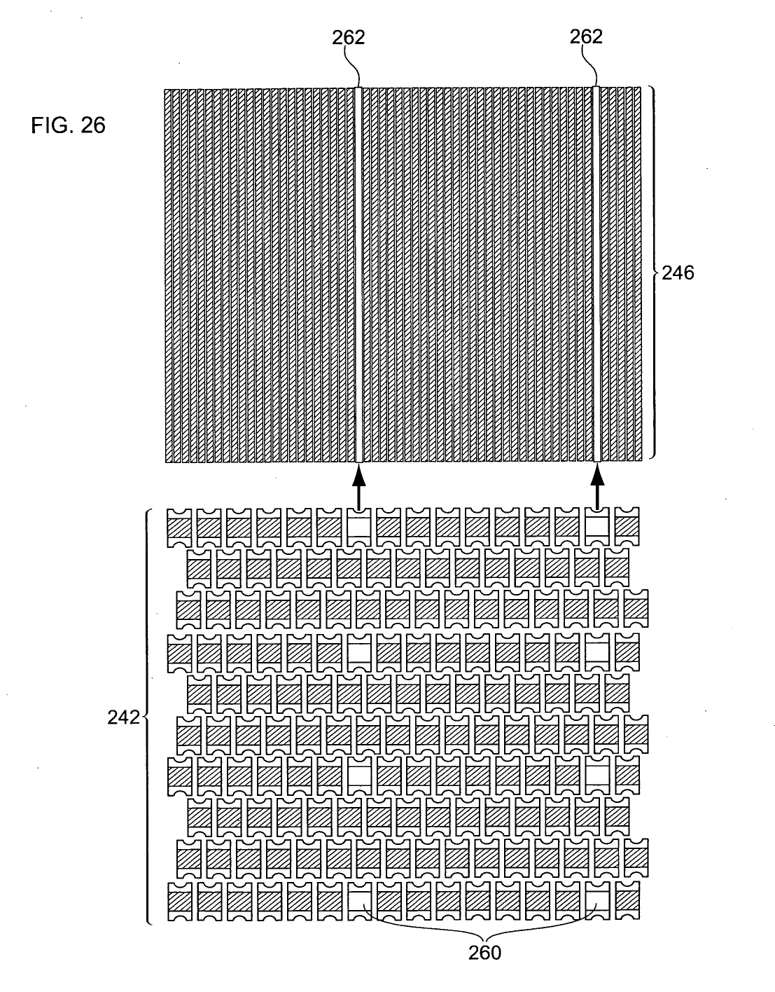

According to one preferred embodiment, the surface mount LED bank 242 is generally formed by a plurality of micro surface-mount light emitting diodes soldered to the surface of a circuit board in staggered rows (see FIG. 26). The LEDs are connected so that columns of the LEDs 260 that are in vertical alignment may be illuminated together. FIGS. 25 and 26 illustrate this configuration. In one embodiment, the circuit board will have the same total vertical and horizontal dimensions as the finished scanning column backlight, and may or may not contain the driver circuitry required to cycle the columns through the appropriate rapid sequential steps. The LED bank can be, ideally, made up of identical high-brightness white LEDs. It may be desirable however, under some circumstances, to use colored LEDs, or a mixture of different colors.

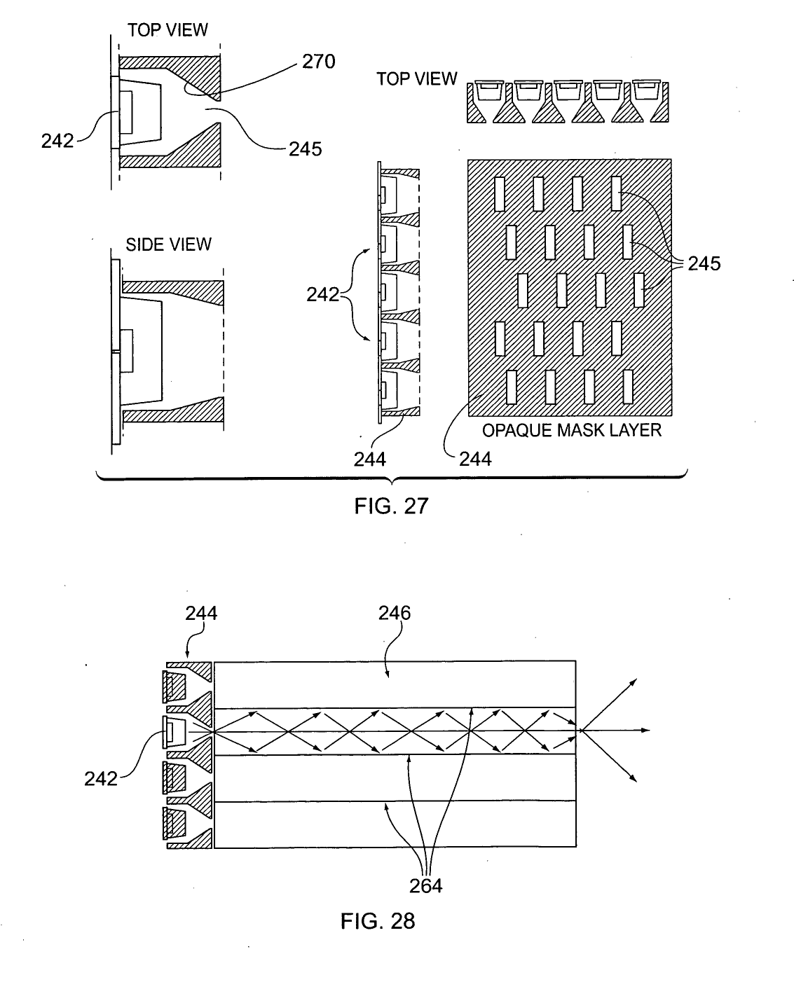

In accordance with one aspect of the invention, the mask layer 244 consists of a rectangular solid, perforated with holes and fitted with indentations or ‘cups’ which individually fit over each LED in the first layer 242, such that the light from any one LED may be seen only through a single narrow hole in the front of the mask. The mask serves to reduce the apparent width of each LED to a width appropriate for interface with each of the narrow stacked light guides. The mask 244 may consist of injection molded or stamped plastic, will be opaque to light, and may be coated with or consist of reflective or high-gloss material. FIG. 27 shows how the mask layer 244 interfaces with the LED bank, allowing some room for internal reflections within the ‘cup’ so as to maximize the light output through the horizontally narrow opening.

The light guides 246 can be formed with, for example, a number of transparent rectangular prisms, possibly made from thin rectangular strips of acrylic or other optical grade material, stacked horizontally and bonded to the mask layer 244. The light guides 246 provide a controlled optical path of a length sufficient for light from the LED bank to spread out vertically in order to evenly illuminate entire columns. The individual light guides are optically segregated from one another by means of an opaque film or coating 264 placed between each layer. In alternative embodiments, the individual light guides 246 can be bonded using some other method that prevents the leak of internally reflected light from one to another. The light guides are attached directly to the mask layer such that light from any one LED is allowed to enter only one light guide. FIG. 28 illustrates this relationship. Bonding is achieved through adhesive, heat bonding, or by mechanical means. The internal reflections are also shown for one column of illuminated LEDs.

A layer of diffusive material 248 is placed very near the front most surface of the stacked light guides 246. Diffusive material 248 serves to diffuse the now-diverged light from the masked LEDs. This has two effects: 1) It makes light from each illuminated column visible from over a wide range of viewing angles; and 2) It serves to eliminate any visible lines that separate one illuminated column from another. A diffusion film of slight thickness, or placed a slight distance from the end of the stacked light guides will serve to slightly blend or ‘feather’ the edges of the columns. This is desirable because, when the columns are cycled at a sufficiently rapid rate, they will blend to form a homogenous rectangular backlight.

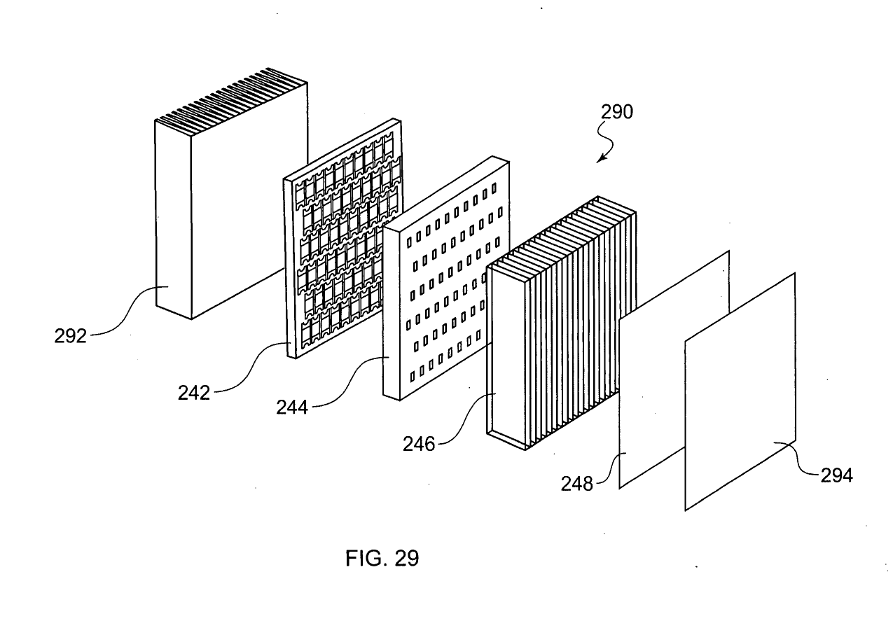

Though the functionality of the invention is fully achieved through the four primary layers described in FIGS. 24-28, another practical embodiment may or may not make use of two additional layers. These layers include a heat sink 292, bonded to the back of the surface mounted LED bank 242, and a gradient compensation film 294, placed over the stacked light guides with the diffusive film (246, 248). FIG. 29 illustrates the system layout with the addition of these other possible layers.

A heat sink 292 may be required in order to prevent overheating, should the LED bank be shown to produce too much heat when operated at desired brightness levels. It is preferred that heat sink 292 retains a relatively thin profile, and add little to the overall thickness of the backlight invention. If required, a fan may also be used in combination with heat sink 292.

In the event that the stacked light guide layer be insufficiently deep to allow fully even spreading of light from the masked LEDs (such is the case with a very shallow set of stacked light guides), a gradient compensations film 294 may be added to the front, which specifically compensates for the uneven spread in brightness. The film 294 will be essentially the subtractive equivalent to the regional brightness gradients seen through the diffused light guides. When placed over the stacked light guides 246 in combination with the diffusive film 248, the gradient compensation film 292 will cause the emerging light to be homogenous in brightness across the height of each column, to within 10% variance in measured brightness.

While there has been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

1. A backlight for use in a scanning aperture display device comprising:
an LED bank having a predetermined configuration; and
a light carrying device positioned in front of said LED bank and having a configuration corresponding to the LED bank configuration, said light carrying device being positioned between said LED bank and a transmissive display of the scanning aperture display device.

2. The backlight according to claim 1, wherein said light carrying device comprises a mask positioned in front of said LED bank and having a plurality of openings corresponding to positions of LEDs in said LED bank.

3. The backlight according to claim 1, wherein said light carrying device comprises:
a mask positioned in front of said LED bank and having a plurality of openings corresponding to positions of LEDs in said LED bank; and
a plurality of stacked light guides positioned in front of said openings in said mask.

4. The backlight according to claim 3, further comprising a diffusive film positioned in front of said stacked light guides, said film diffusing diverged light from the masked LED bank.

5. The backlight according to claim 3, wherein said LED bank comprises of a plurality of LEDs arranged such that columns of LEDs that are aligned with each other may be illuminated together.

6. The backlight according to claim 5, wherein said openings in said mask comprise a larger opening adapted to fit over each LED in said LED bank and a narrower opposing opening adapted to transmit the light generated by the LED to the stacked light guides.

7. The backlight according to claim 5, wherein the LED alignment is horizontal.

8. The backlight according to claim 5, wherein the LED alignment is vertical.

9. The backlight according to claim 1, wherein said LED bank comprises a plurality of surface mount LEDs

10. The backlight according to claim 5, wherein illuminated columns of LEDs have a width equal to a width of an image pixel.

11. The backlight according to claim 5, wherein illuminated columns of LEDs have a width in a range of 0.2 mm to 0.5 mm.

12. The backlight according to claim 5, wherein illuminated columns of LEDs have a width greater than 0.5 mm.

13. The backlight according to claim 5, wherein said columns are illuminated in a succession corresponding with a rate of change of the apertures of the scanning aperture display device.

14. A backlight for use in a scanning aperture display device comprising:
an LED bank having a predetermined configuration;
a light carrying device positioned in front of said LED bank and having a configuration corresponding to the LED bank configuration, said light carrying device being positioned between said LED bank and a transmissive display of the scanning aperture display device; and
a heat dissipating device positioned behind said LED bank for dissipating heat generated by said LED bank.

15. The backlight according to claim 14, wherein said light carrying device comprises:
a mask positioned in front of said LED bank and having at least one opening corresponding to each LED in said LED bank; and
a plurality of stacked light guides positioned in front of said openings in said mask.

16. The backlight according to claim 15, wherein said openings in said mask comprise a larger opening on an LED engaging side and a narrower opening on an opposing light emitting side, said narrower opening having a size corresponding to a size of one of said stacked light guides.

17. The backlight according to claim 15, further comprising:
a diffusive film positioned in front of said stacked light guides for diverging light from the masked LEDs; and
a gradient compensation film positioned in front of said diffusive film for homogenizing brightness across a display surface of the scanning aperture display device.

18. The backlight according to claim 15, wherein said heat dissipating device comprises a heat sink.

19. The backlight according to claim 15, wherein said LED bank comprises a plurality of LEDs arranged such that columns of LEDs that are aligned with each other may be illuminated together.

20. The backlight according to claim 19, wherein said LED alignment is vertical.

21. The backlight according to claim 15, wherein said LED bank comprises surface mount LEDs.
